(19) United States
(12) Patent Application Publication
(10) Pub. No.: US 2025/0347890 A1
(43) Pub. Date: Nov. 13, 2025

(54) LENS DRIVING DEVICE AND OPTICAL APPARATUS

(71) Applicant: Changzhou AAC Raytech Optronics Co., Ltd., Changzhou City (CN)

(72) Inventors: Tongming Xu, Changzhou (CN); Aixin Xu, Changzhou (CN); Nian Xiao, Changzhou (CN); Suohe Wei, Changzhou (CN); Limei Zhao, Changzhou (CN)

(21) Appl. No.: 19/095,081

(22) Filed: Mar. 31, 2025

Related U.S. Application Data
(63) Continuation of application No. PCT/CN2024/091871, filed on May 9, 2024.

(51) Int. Cl. G02B 7/08; G02B 27/64

(52) U.S. Cl. CPC G02B 7/08; G02B 27/646

(57) ABSTRACT

A lens driving device and an optical apparatus. An attractive force between the first magnetic conductor and the first magnet causes the first bracket and the first shell to clamp the first ball, the first magnet drives a first coil to drive the first bracket and an imaging sensor to move in a plane perpendicular to an optical axis, and a first position detection element is configured to detect a position of the first magnet. An attractive force between the second magnetic conductor and the second magnet causes the second bracket and the support bracket to clamp the ball set, the second magnet drives a second coil to drive a support bracket and a lens to move along the optical axis, and a second position detection element is configured to detect a position of the second magnet. The yield loss in the manufacturing process is reduced.

### TECHNICAL FIELD

The present disclosure relates to the technical field of image shooting devices, and in particular, to a lens driving device and an optical apparatus.

### BACKGROUND

In recent years, with the improvement of people's requirements for life quality, requirements for image shooting device required in daily life have also be gradually increased. In order to improve the imaging quality, a lens driving device is widely applied in various fields. The lens driving device generally has an auto focusing (AF) function and an optical image stabilization (OIS) function. An auto focusing structure is provided in the lens driving device, and focusing of the image shooting device can be achieved by driving the lens to move. Meanwhile, an optical image stabilization structure is provided to prevent shaking generated during a focusing process, thereby improving the imaging quality.

In an existing lens driving device, an auto focusing structure and an optical image stabilization structure are usually arranged in a same device. The auto focusing structure and the optical image stabilization structure usually share a magnet to drive the lens to perform focusing and achieve image stabilization. At the same time, a stabilization ball is used in the device to achieve the image stabilization function. Although the lens driving device can simultaneously achieve lens focusing and image stabilization, during a process of the lens driving device, since the auto focusing function and the optical image stabilization function are achieved in a same device, if any one of the auto focusing structure and the optical image stabilization structure is damaged during a manufacturing process, a manufacturing success rate of the entire lens driving device is affected, and a manufacturing cost of the lens driving device is increased. In addition, an existing lens driving device usually uses only one kind of stabilization ball, making the image stabilization performance of the lens driving device poor.

Therefore, there is an urgent need in the art for a lens driving device capable of solving the above-mentioned technical problems.

### SUMMARY

The embodiments of the present disclosure provide a lens driving device and an optical apparatus, which are at least beneficial to solving the problems of low manufacturing success rate and poor image stabilization performance of the lens driving device.

According to some embodiments of the present disclosure, a first aspect of embodiments of the present disclosure provides a lens driving device capable of mounting an imaging sensor and a lens having an optical axis. The lens driving device includes: a first shell including a first receiving cavity; a first bracket movably arranged in the first receiving cavity and configured to fix the imaging sensor; a first coil fixed to the first bracket; a first magnet fixed in the first shell and arranged opposite to the first coil along a direction of the optical axis; a first ball arranged between the first bracket and an inner wall of the first shell; a first magnetic conductor fixed to the first bracket and arranged opposite to the first magnet, wherein an attractive force is generated between the first magnetic conductor and the first magnet to cause the first bracket and the first shell to clamp the first ball, and the first magnet drives the first coil to drive the first bracket and the imaging sensor to move in a plane perpendicular to the optical axis when the first coil is energized; a first position detection element configured to detect a position of the first magnet; a second shell including a second receiving cavity and fixedly connected to an object side of the first shell; a support bracket arranged in the second receiving cavity and including a through-hole, the lens being arranged in the through-hole; a second bracket arranged at a periphery of the support bracket; a second magnet fixed to the support bracket; a second coil fixed in the second shell, arranged opposite to the second magnet and at a side of the second magnet away from the optical axis; a ball set arranged in a gap between the second bracket and the support bracket; a second magnetic conductor arranged opposite to the second magnet, wherein an attractive force is generated between the second magnetic conductor and the second magnet to cause the second bracket and the support bracket to clamp the ball set, the second magnet drives the second coil to drive the support bracket and the lens to move along the direction of the optical axis when the second coil is energized; and a second position detection element configured to detect a position of the second magnet.

As an improvement, the lens driving device further includes: an upper frame arranged in the first receiving cavity, wherein the upper frame abuts against the first shell; a surface of the first bracket facing the upper frame is provided with at least one first receiving groove, each of the at least one first receiving groove and a plane of the upper frame facing the first bracket form a receiving space, and one first ball is received in one receiving space.

As an improvement, the lens driving device further includes: a ball support plate, wherein two ball support plates are provided and arranged at an object side and an image side of the first ball, and one ball support plate is arranged at a bottom of the first receiving groove.

As an improvement, the ball set includes three second balls arranged along the direction of the optical axis, and wherein a diameter of each of two second balls adjacent to an object side and an image side is greater than a diameter of a second ball arranged at a middle position.

As an improvement, the diameter of each of the two second balls adjacent to the object side and the image side is within a range from 0.6 mm to 1.0 mm, and the diameter of the second ball arranged at the middle position is within a range from 0.55 mm to 0.95 mm.

As an improvement, the support bracket is provided with a clamping groove along a circumferential direction, and a side of the second magnet away from the second coil abuts against an inner wall of the clamping groove.

As an improvement, the lens driving device further includes: a first circuit board sandwiched between the first coil and the first bracket and electrically connected to the first position detection element; a second circuit board provided between the second magnetic conductor and the second bracket and electrically connected to the second position detection element; and a planar circuit board fixedly connected to the first shell and electrically connected to the first circuit board.

As an improvement, the first position detection element is configured to transmit an electrical signal including a position information of the first magnet to the planar circuit board.

As an improvement, the second position detection element is configured to transmit an electrical signal including a position information of the second magnet to the planar circuit board.

As an improvement, the lens driving device further includes: a spring piece, wherein the support bracket is formed as a square ring shape, two spring pieces are provided and arranged at two opposite corners of the support bracket, and the spring piece is electrically connected to the second circuit board.

As an improvement, the first magnet drives the first coil to drive the first bracket and the imaging sensor to move along the direction of the optical axis when the first coil is energized.

As an improvement, four bosses are provided at a surface of the first bracket away from the first coil, and the four bosses are arranged at four corners of the first bracket.

According to some embodiments of the present disclosure, a second aspect of embodiments of the present disclosure provides an optical apparatus, including a lens driving device capable of mounting an imaging sensor and a lens having an optical axis. The lens driving device includes: a first shell including a first receiving cavity; a first bracket movably arranged in the first receiving cavity and configured to fix the imaging sensor; a first coil fixed to the first bracket; a first magnet fixed in the first shell and arranged opposite to the first coil along a direction of the optical axis; a first ball arranged between the first bracket and an inner wall of the first shell; a first magnetic conductor fixed to the first bracket and arranged opposite to the first magnet, wherein an attractive force is generated between the first magnetic conductor and the first magnet to cause the first bracket and the first shell to clamp the first ball, and the first magnet drives the first coil to drive the first bracket and the imaging sensor to move in a plane perpendicular to the optical axis when the first coil is energized; a first position detection element configured to detect a position of the first magnet; a second shell including a second receiving cavity and fixedly connected to an object side of the first shell; a support bracket arranged in the second receiving cavity and including a through-hole, the lens being arranged in the through-hole; a second bracket arranged at a periphery of the support bracket; a second magnet fixed to the support bracket; a second coil fixed in the second shell, arranged opposite to the second magnet and at a side of the second magnet away from the optical axis; a ball set arranged in a gap between the second bracket and the support bracket; a second magnetic conductor arranged opposite to the second magnet, wherein an attractive force is generated between the second magnetic conductor and the second magnet to cause the second bracket and the support bracket to clamp the ball set, the second magnet drives the second coil to drive the support bracket and the lens to move along the direction of the optical axis when the second coil is energized; and a second position detection element configured to detect a position of the second magnet.

The technical solutions provided by the embodiments of the present disclosure have at least the following advantages.

According to the embodiments of the present disclosure, an auto focusing structure and an optical image stabilization structure are configured as two independent devices, including: a first shell including a first receiving cavity; a first bracket movably arranged in the first receiving cavity and configured to fix the imaging sensor; a first coil fixed to the first bracket; a first magnet fixed in the first shell and arranged opposite to the first coil along a direction of the optical axis; a first ball provided between the first bracket and an inner wall of the first shell; a first magnetic conductor fixed to the first bracket and arranged opposite to the first magnet, an attractive force being generated between the first magnetic conductor and the first magnet to cause the first bracket and the first shell to clamp the first ball, and the first magnet driving the first coil to drive the first bracket and the imaging sensor to move in a plane perpendicular to the optical axis when the first coil is energized; a first position detection element configured to detect a position of the first magnet; a second shell including a second receiving cavity and fixedly connected to an object side of the first shell; a support bracket arranged in the second receiving cavity and including a through-hole, the lens being arranged in the through-hole; a second bracket arranged at a periphery of the support bracket; a second magnet fixed to the support bracket; a second coil fixed in the second shell and arranged opposite to the second magnet and arranged at a side of the second magnet away from the optical axis; a ball set arranged in a gap between the second bracket and the support bracket; a second magnetic conductor arranged opposite to the second magnet, an attractive force being generated between the second magnetic conductor and the second magnet to cause the second bracket and the support bracket to clamp the ball set, and the second magnet driving the second coil to drive the support bracket and the lens to move along the direction of the optical axis when the second coil is energized; and a second position detection element configured to detect a position of the second magnet. In the embodiments of the present disclosure, the auto focusing device and the optical image stabilization device are configured as two independent structures, which are independently formed and processed and then assembled, effectively reducing the yield loss in the manufacturing process of the lens driving device, thereby reducing the manufacturing cost. Meanwhile, two types of balls are provided at the auto focusing device and at the optical image stabilization device, respectively, thereby further improving the image stabilization performance of the lens driving device.

### BRIEF DESCRIPTION OF DRAWINGS

One or more embodiments are exemplarily described with reference to the corresponding drawings. These exemplary descriptions do not constitute limitations on the embodiments of the present disclosure, unless otherwise stated, the figures in the drawings do not constitute a proportional limitation. In order to better illustrate the technical solutions in the embodiments of the present disclosure or in the conventional technology, the drawings to which reference is made in the description of the embodiments are described below briefly, and apparently the drawings in the following description are merely some of the embodiments of the present disclosure, and those ordinarily skilled in the art can further derive from these drawings other drawings without any creative efforts.

FIG. 1 is an exploded view of a lens driving device according to an embodiment of the present disclosure;

FIG. 2 is an exploded view of an optical image stabilization device according to an embodiment of the present disclosure;

FIG. 3 is an exploded view of an auto focusing device according to an embodiment of the present disclosure;

FIG. 4 is a side view of a lens driving device according to an embodiment of the present disclosure;

FIG. 5 is a rear view of a first bracket according to an embodiment of the present disclosure;

FIG. 6 is a front view of a partial structure of an optical image stabilization device according to an embodiment of the present disclosure;

FIG. 7 is a rear view of a partial structure of an optical image stabilization device according to an embodiment of the present disclosure;

FIG. 8 is a perspective view of an upper frame according to an embodiment of the present disclosure;

FIG. 9 is a schematic structural diagram of a lens driving device assembled with a lens according to an embodiment of the present disclosure;

FIG. 10 is a top view of a lens driving device assembled with a lens according to an embodiment of the present disclosure;

FIG. 11 is a sectional view along A-A shown in FIG. 10;

FIG. 12 is a side view of a lens driving device assembled with a lens according to an embodiment of the present disclosure;

FIG. 13 is a sectional view along B-B shown in FIG. 12;

FIG. 14 is a partial structural schematic diagram of an embodiment of the present disclosure;

FIG. 15 is a partial structural schematic diagram of an embodiment of the present disclosure;

FIG. 16 is an exploded view of a lens driving device and a lens according to an embodiment of the present disclosure;

FIG. 17 is an exploded view of a lens driving device and a lens according to an embodiment of the present disclosure; and

FIG. 18 is a schematic structural diagram of a planar circuit board according to an embodiment of the present disclosure.

### DESCRIPTION OF EMBODIMENTS

In order to better illustrate the objectives, technical solutions and advantages of the embodiments of the present disclosure, various embodiments of the present disclosure will be described in details below with reference to the drawings. However, those of ordinary skill in the art will appreciate that in various embodiments of the present disclosure, some technical details are set forth for the reader to better understand the present disclosure. However, even without these technical details and various changes and modifications based on the following embodiments, the technical solutions claimed in the present disclosure may still be implemented.

In the embodiments of the present disclosure, terms such as “upper”, “lower”, “above”, “under” “left”, “right”, “front”, “back/rear”, “top”, “bottom”, “inner”, “outer”, “middle”, “vertical”, “horizontal”, “transverse”, and “longitudinal” indicate that the orientation or position relationship is based on the orientation or position relationship shown in the drawings. These terms are primarily intended to better describe the present disclosure and its embodiments, and are not intended to limit that the indicated devices, elements, or components must have a particular orientation, or be constructed and operated in a particular orientation.

In addition, some of the foregoing terms may be used to indicate an orientation or a location relationship, and may also be used to indicate other meanings, for example, the term “on/at/to” may also be used to indicate some attachment relationship or connection relationship in some cases. For those skilled in the art, the specific meanings of these terms in the present disclosure may be understood according to specific situations.

In addition, terms “mounting”, “configuring”, “provided with”, “forming”, “connecting” and “coupling” should be understood broadly. For example, it may be a fixed connection, a detachable connection, or an integral structure; a mechanical connection, or an electrical connection; a direct connection, or an indirect connection through an intermediate medium, or an internal communication between two devices, elements, or components. For those skilled in the art, specific meanings of the preceding terms in the present disclosure may be understood based on specific situations.

In addition, the terms such as “first” and “second” are mainly used to distinguish different devices, elements or components (specific types and configurations may be the same or different), and are not used to indicate or imply relative importance and quantity of the indicated devices, elements or components. Unless otherwise indicated, “multiple/a plurality of” means two or more.

It can be known from the background that the conventional lens driving device has a high loss rate and poor image stabilization performance.

Embodiments of the present disclosure provide a lens driving device, and various embodiments of the present disclosure will be described in details below with reference to the drawings. However, those of ordinary skill in the art will appreciate that in the various embodiments of the present disclosure, numerous technical details are set forth for the reader to better understand the present disclosure. However, even without these technical details and various variations and modifications based on the following embodiments, the technical solutions claimed in the present disclosure can still be implemented.

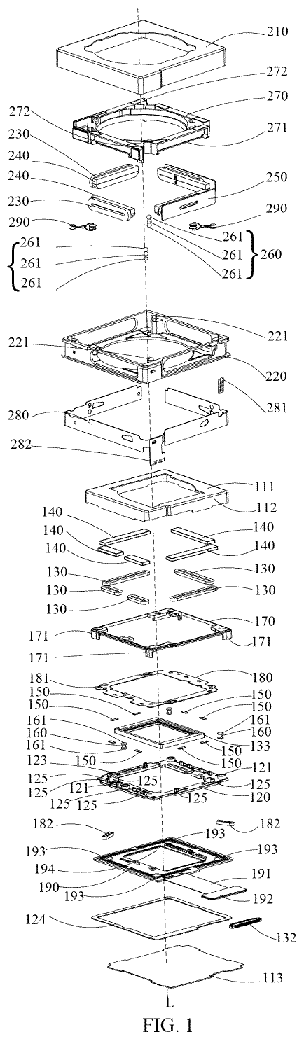

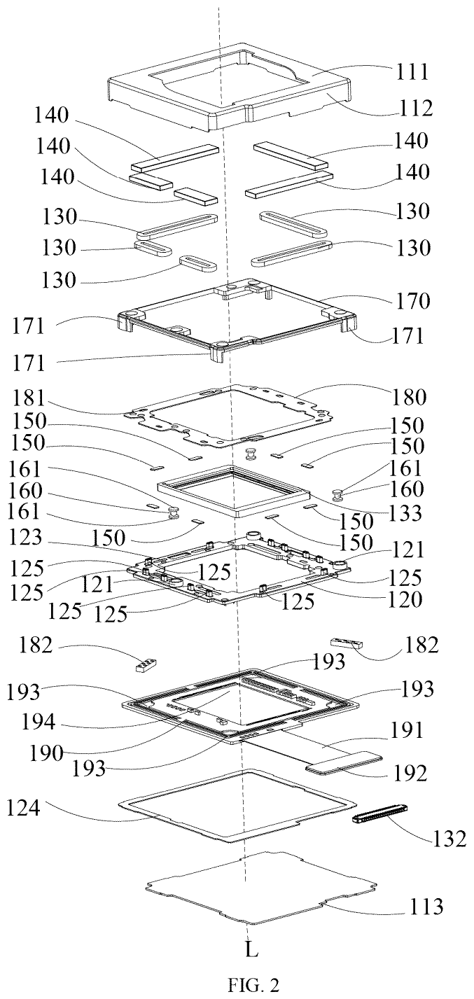

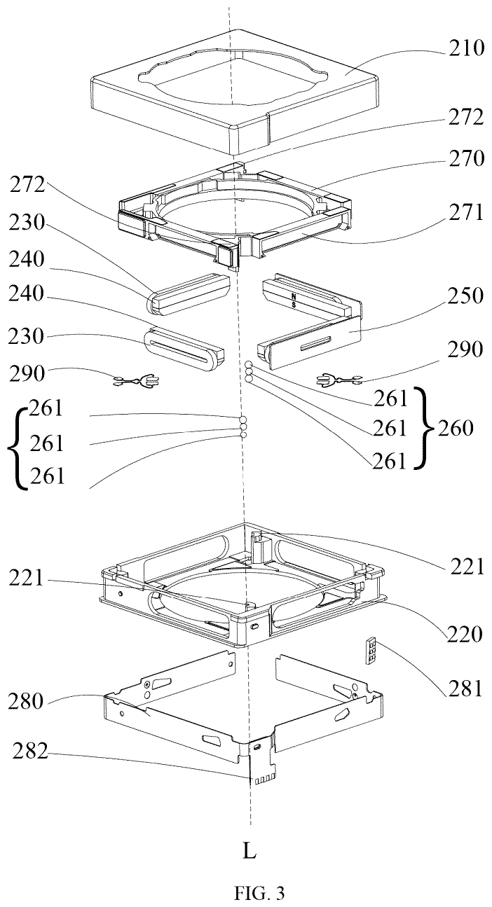

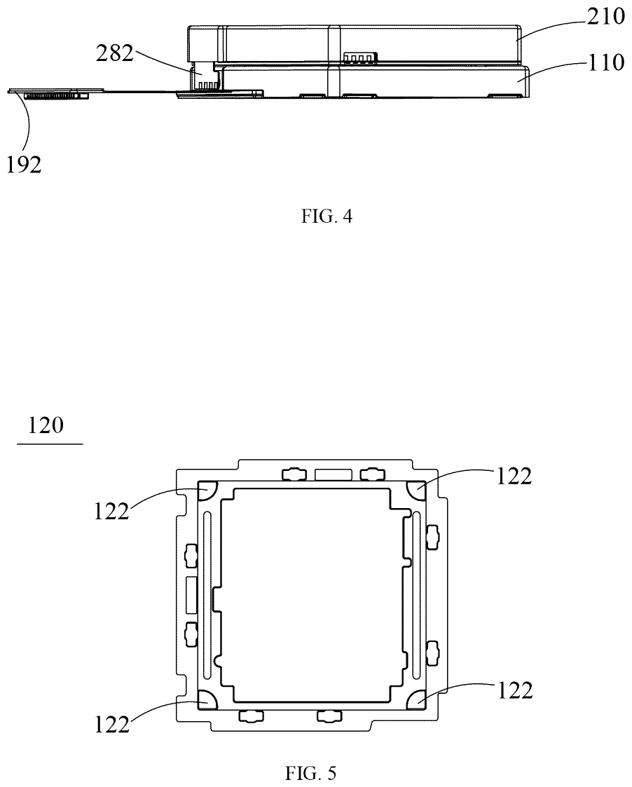

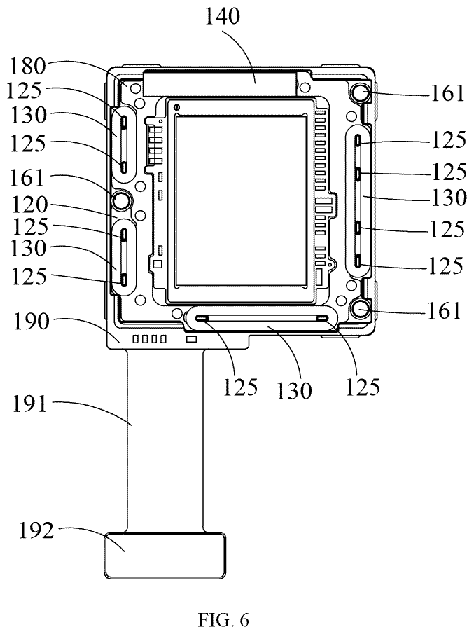

FIG. 1 is an exploded view of a lens driving device according to an embodiment of the present disclosure. FIG. 2 is an exploded view of an optical image stabilization device according to an embodiment of the present disclosure. FIG. 3 is an exploded view of an auto focusing device according to an embodiment of the present disclosure. FIG. 4 is a top view of a lens driving device according to an embodiment of the present disclosure.

Referring to FIG. 1 to FIG. 4, an embodiment of the present disclosure provides a lens driving device, capable of mounting an imaging sensor and a lens having an optical axis L, and including: a first shell 110 including a first receiving cavity 1101; a first bracket 120 movably arranged in the first receiving cavity 1101 and configured to fix the imaging sensor; a first coil 130 fixed to the first bracket 120; a first magnet 140 fixed in the first shell 110 and arranged opposite to the first coil 130 and at a side of the first coil 130 away from the first bracket 120; a first ball 160 arranged between the first bracket 120 and an inner wall of the first shell 110; a first magnetic conductor 150 fixed to the first bracket 120 and arranged opposite to the first magnet 140, an attractive force being generated between the first magnetic conductor 150 and the first magnet 140 to cause the first bracket 120 and the first shell 110 to clamp the first ball 160, and the first magnet 140 driving the first coil 130 to drive the first bracket 120 and the imaging sensor to move in a plane perpendicular to the optical axis L when the first coil 130 is energized; and a first position detection element configured to detect a position of the first magnet 140.

In an example, the first coil 130 is an image stabilization coil, and the first magnet 140 is an image stabilization magnet. The first coil 130 and the first magnet 140 correspond to each other one by one and are arranged opposite to each other, and a gap is formed between the first coil and the first magnet. When the first coil 130 is energized, a Lorentz force is generated between the first coil 130 and the first magnet 140, so that the first bracket 120 moves in a plane perpendicular to the optical axis L or in a direction rotating about the optical axis L. The first bracket 120 is relatively fixed in the direction of the optical axis L through an attractive force between the first magnet 140 and the first magnetic conductor, and the first ball 160 may roll in a plane perpendicular to the optical axis L or in the direction rotating about the optical axis L. That is, the first ball 160 may roll relative to the first bracket 120. When the first bracket 120 is subjected to the Lorentz force between the first coil 130 and the first magnet 140, the first bracket 120 may also move in a plane perpendicular to the optical axis L or in a direction rotating about the optical axis L, to compensate for the shaking during an image shooting process, thereby achieving image stabilization.

The embodiments of the present disclosure provide a lens driving device, which further includes: a second shell 210 including a second receiving cavity 2101 and fixedly connected to an object side of the first shell 110; a support bracket 270 arranged in the second receiving cavity 2101 and including a through-hole, the lens 100 being arranged in the through-hole; a second support 220 arranged at a periphery of the support bracket 270; a second magnet 240 fixed to the support bracket 270; a second coil 230 fixed in the second shell 210 and arranged opposite to the second magnet 240 and at a side of the second magnet 240 away from the optical axis L; a ball set 260 arranged in a gap between the second bracket 220 and the support bracket 270; a second magnetic conductor 250 fixed to the second circuit board 280 and arranged opposite to the second magnet 240, an attractive force being generated between the second magnetic conductor 250 and the second magnet 240 to cause the second bracket 220 and the support bracket 270 to clamp the ball set 260, the second magnet 240 driving the second coil 230 to drive the support bracket 270 and the lens 100 to move along the direction of the optical axis L when the second coil 230 is energized; and a second position detection element configured to detect a position of the second magnet 240.

In an example, the second coil 230 is a focusing coil, and the second magnet 240 is a focusing magnet. The second coil 230 and the second magnet 240 correspond to each other one by one and arranged opposite to each other, and a gap is formed between the second coil 230 and the second magnet 240. When the second coil 230 is energized, a Lorentz force is generated between the second coil 230 and the second magnet 240, so that the support bracket 270 moves in a direction along the optical axis L. The support bracket 270 is relatively fixed in the direction of the optical axis L through an attraction force between the second magnet 240 and the second magnetic conductor 250, and the ball set 260 can move in the direction along the optical axis L. That is, the ball set 260 can roll relative to the support bracket 270, so that the ball set 260 can guide the lens to move in the direction of the optical axis L of the lens, thereby achieving the focusing function of the lens 100.

In an embodiment of the present disclosure, the first magnetic conductor 150 and the second magnetic conductor 250 each may be a magnetic yoke. On one hand, an attractive force may be generated between the first magnetic conductor 150 and the first magnet 140 to cause the first bracket 120 and the first shell 110 to clamp the first ball 160, and an attractive force may be generated between the second magnetic conductor 250 and the second magnet 240 to cause the second support 220 and the support bracket 270 to clamp the ball set 260. On the other hand, when the first coil 130 is not energized, the first magnetic conductor 150 can provide a restoring force for the first bracket 120; and when the second coil 230 is not energized, the second magnetic conductor 250 can provide a restoring force for the support bracket.

In an embodiment of the present disclosure, the first shell 110 includes a top plate 111, four side plates 112 surrounding four sides of the top plate 111, and a bottom plate 113 detachably connected to the top plate 111. The top plate 111 includes a through-hole, and a shape of the through-hole matches a shape of a cross section of the lens facing an object side, for arranging the lens. The top plate 111 and the bottom plate 113 can be connected by snapping, clamping or screws, or can be integrally formed, no limitation is made herein. The top plate 111, the side plate 112 and the bottom plate 113 enclose a first receiving cavity 1101.

FIG. 5 is a rear view of a first bracket according to an embodiment of the present disclosure. Referring to FIG. 1, FIG. 2, and FIG. 5, a side of the first bracket 120 facing an object side is formed as a rectangular shape. Three first coils 130 are arranged at three sides of the rectangular shape, and another two first coils 130 are arranged in parallel and spaced from each other at another side of the rectangular shape. A first magnet 140 is provided opposite to the first coil 130 and at a side of the first coil 130 away from the first bracket 120. Each first coil 130 corresponds to one first magnet 140, and the first coil 130 and the first magnet 140 are arranged opposite to each other towards an object side. It can be understood that, the first coil(s) 130 and the first magnet(s) 140 may also have other numbers, for example, two, three or more are provided, as long as the force applied to the first bracket 120 is kept balanced, and the stability and the reliability of an image shooting module are improved, no limitation is made herein.

In an embodiment of the present disclosure, a surface of the first bracket 120 facing the first coil 130 is provided with a first mounting groove 123, for arranging the first magnetic conductor 150. A surface of the first bracket 120 facing the first coil 130 is provided with eight first mounting grooves 123. A surface of the first bracket 120 facing the first coil 130 includes four sides, and two first mounting grooves 123 are provided at each side. A shape of the first mounting groove 123 matches a shape of the first magnetic conductor 150. Eight first magnetic conductors 150 are received in eight first mounting grooves 123, for generating an attractive force between the first magnetic conductor 150 and the first magnet 140. In some other embodiments of the present disclosure, the number and the shape of the first magnetic conductor(s) 150 may be configured according to actual needs, no limitation is made herein.

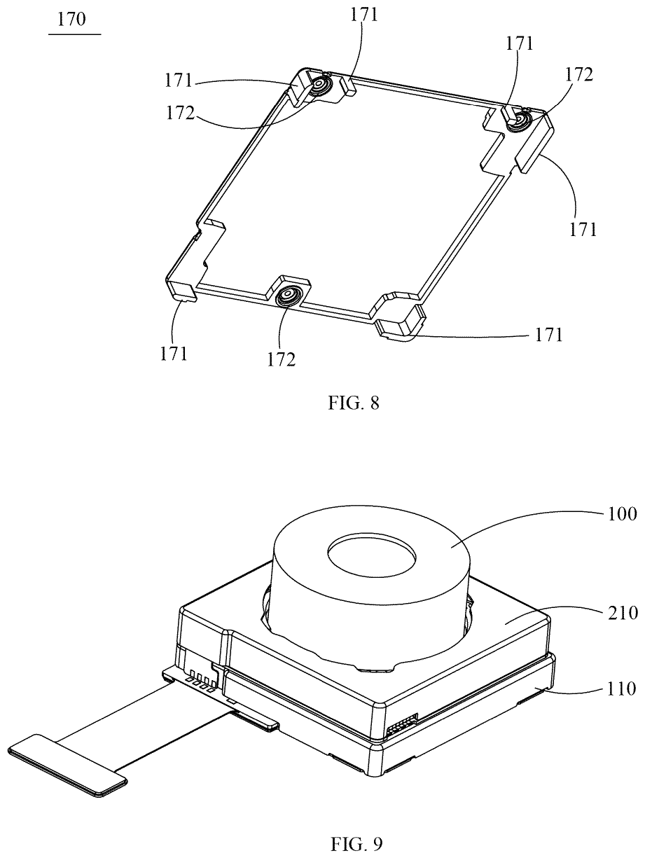

FIG. 8 is a perspective view of an upper frame 170 according to an embodiment of the present disclosure. Referring to FIG. 1, FIG. 2 and FIG. 8, in an embodiment of the present disclosure, an upper frame 170 is further included and arranged in the first receiving cavity 1101. The upper frame 170 abuts against the first shell 110, and a surface of the first bracket 120 facing the upper frame 170 is provided with at least one first receiving groove 121. Each first receiving groove 121 and a plane of the upper frame 170 facing the first bracket 120 form a receiving space, and one first ball 160 is received in one receiving space.

The first receiving groove 121 is formed as a cylindrical shape. One first receiving groove 121 is formed at a side of a surface of the first bracket 120 facing the upper frame 170, and two first receiving grooves 121 are formed at another side opposite thereto. One first ball 160 is received in each first receiving groove 121. In some embodiments of the present disclosure, at least three first balls 160 may be provided, such as three, four, five or more, as long as the first bracket 120 is prevented from being tilted when moving in a direction perpendicular to the optical axis L, which would affect the imaging quality.

In an embodiment of the present disclosure, the lens driving device further includes: a ball support plate 161. Two ball support plates 161 are arranged at an object side and an image side of the first ball 160. The ball support plate 161 is arranged at a bottom of the first receiving groove 121. The ball support plate 161 is preferably a ceramic plate, which is non-conductive and thus does not affect the normal operation of the lens driving device.

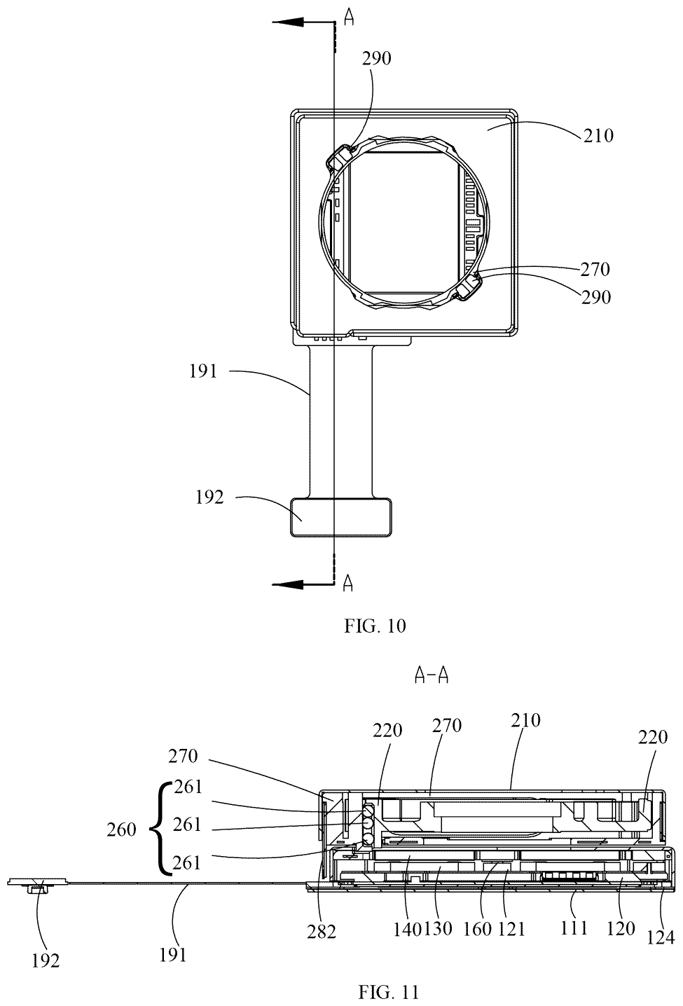

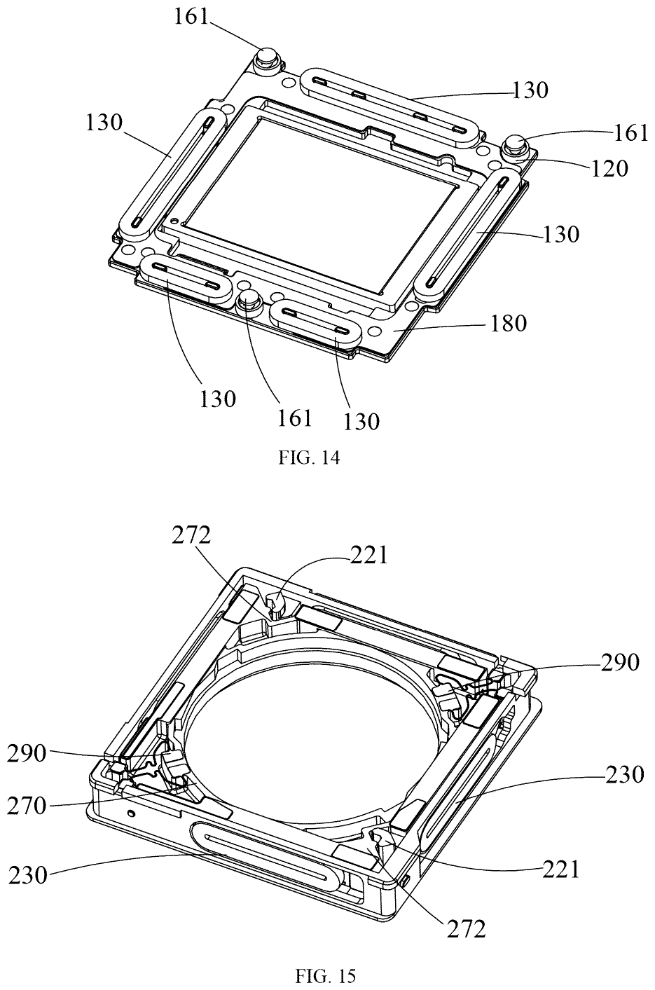

As shown in FIG. 8, FIG. 10, FIG. 11 and FIG. 14, a supporting groove 172 is formed at a surface of the upper frame 170 facing the first ball 160. The number of the supporting groove(s) 172 is the same as the number of the first ball(s) 160, and the position of the supporting groove(s) 172 is arranged opposite to the position of the first ball(s) 160, for mounting one first ball 160 support plate located at an object side of the first ball 160, so that the first ball 160 is not easily separated from the first receiving groove 121. The first ball 160 only rolls in the first receiving groove 121 to prevent the lens from shaking.

In an embodiment of the present disclosure, an optical filter 133 is further included. The optical filter 133 is fixed to a planar circuit board 190.

The second shell 210 and the second bracket 220 each are provided with a through-hole, and a shape of the through-hole matches a shape of the lens.

In some embodiments of the present disclosure, the support bracket 270 is provided with a clamping groove 271 along a circumferential direction, and a side of the second magnet 240 away from the second coil 230 abuts against a top of the clamping groove 271. The support bracket 270 and the lens move along the direction of the optical axis L under an action of the second magnet 240 and the second coil 230, and the support bracket 270 and the lens are relatively fixed.

Four second coils 230 are provided along a circumferential direction of the support bracket 270. The number of the second magnets 240 is the same as the number of the second coils 230, and each second coil 230 corresponds to one second magnet 240. A gap is formed between the second shell and the second bracket, and the second magnetic conductor is arranged at this gap. The second magnetic conductor 250 is arranged at a side of the second coil 230 away from the second magnet 240. An attractive force and a corresponding restoring force are generated between the second magnetic conductor 250 and the second magnet 240, so that the support bracket 270 remains relatively stable when no focusing, and thus the second support 220 and the support bracket 270 clamp the ball set 260. It can be understood that the second coil(s) 230 and the second magnet(s) 240 may also have other numbers, for example, two, three or more are provided, as long as the force applied to the second bracket 220 is kept balanced and the stability and the reliability of an image shooting module are improved, no limitation is made herein.

It should be noted that since the second bracket 220 and the support bracket 270 need to clamp the ball set 260 by means of a magnetic force between the second magnet 240 and the second magnetic conductor 250, when arranging the second magnetic conductor 250, it needs to ensure that the total magnetic force between the second magnet 240 and the second magnetic conductor 250 is in an unbalanced state, that is, a resultant force of the magnetic force is not zero.

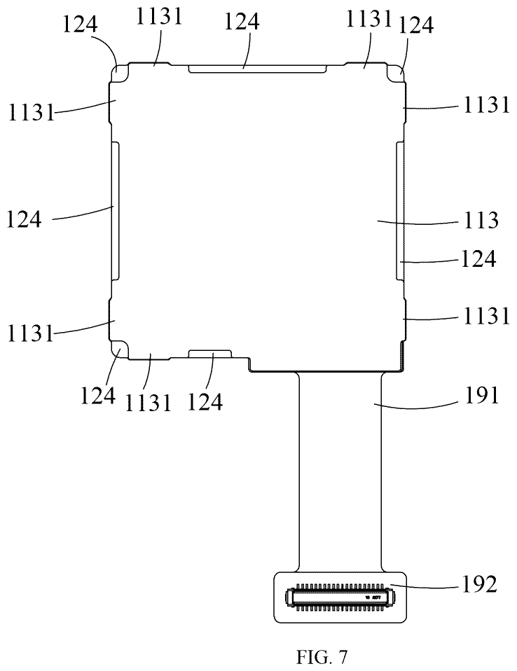

Referring to FIG. 1, FIG. 2, FIG. 3 and FIG. 7, it can be seen that, in an embodiment of the present disclosure, the lens driving device further includes: a first circuit board 180 sandwiched between the first coil 130 and the first bracket 120, and electrically connected to a first position detection element 182; a second circuit board 280 arranged between the second magnetic conductor 250 and the second bracket 220, and electrically connected to a second position detection element 281; and a planar circuit board 190 fixedly connected to the first shell 110, and electrically connected to the first circuit board 180.

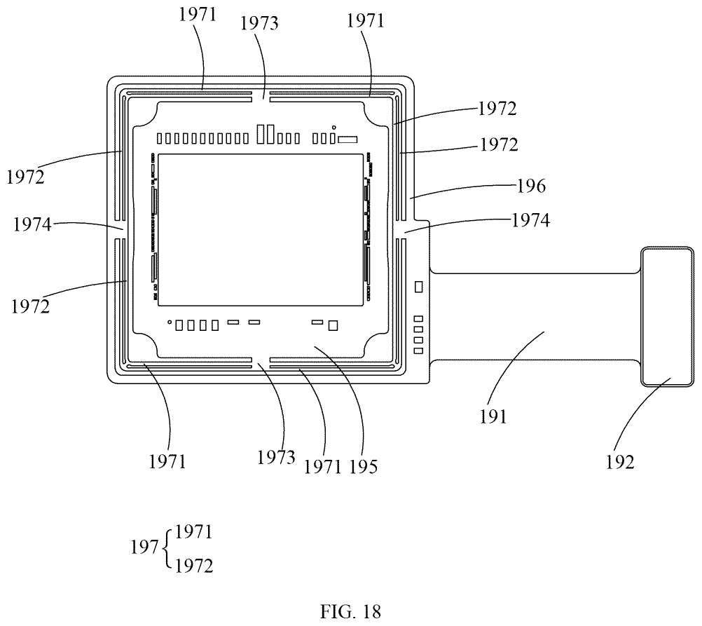

FIG. 18 is a schematic structural diagram of a planar circuit board according to an embodiment of the present disclosure. Referring to FIG. 2 and FIG. 18, in an embodiment of the present disclosure, the planar circuit board 190 includes a planar circuit board body 195, a planar circuit board fixing portion 196, and an elastic connection portion 197. The frame-shaped elastic connection portion 197 is elastically connected to the planar circuit board body 195 and the planar circuit board fixing portion 196, respectively, so that the planar circuit board body 195 can move in a plane perpendicular to the optical axis L, thereby driving the imaging sensor 194 to move.

With continued reference to FIG. 18, the elastic connection portion 197 may include two sets of first elastic edges 1971 and two sets of second elastic edges 1972. The two sets of first elastic edges 1971 are correspondingly arranged, and each set of first elastic edges 1971 is connected to the planar circuit board body 195 through a first connection arm 1973. The two sets of second elastic edges 1972 are correspondingly arranged, and each set of second elastic edges 1972 is connected to the planar circuit board fixing portion 196 through a second connection arm 1974. As a result, the planar circuit board body 195 can move, relative to the planar circuit board fixing portion 196, in a plane perpendicular to the direction of the optical axis L, thereby driving the imaging sensor 194 to move.

In some examples, each set of first elastic edges 1971 may include a plurality of first elastic edges 1971 arranged in parallel with one another, and each set of second elastic edges 1972 may include a plurality of second elastic edges 1972 arranged in parallel with one another, thereby ensuring the strength and the restoring force of the elastic connection portion 197. For example, referring to FIG. 18, each set of first elastic edges 1971 may include two first elastic edges 1971 arranged in parallel, and each set of second elastic edges 1972 may include two second elastic edges 1972 arranged in parallel.

Referring to FIG. 2, it can be seen that the planar circuit board 190 further includes a plurality of avoidance spaces 193, all of which are symmetrically arranged. In an example, a surface of the planar circuit board 190 facing the first bracket 120 includes four sides, and the planar circuit board 190 may be provided with four avoidance spaces 193 that are arranged at four corners of the planar circuit board 190, respectively. Accordingly, referring to FIG. 5, four bosses 122 are distributed at a surface of the first bracket 120 away from the first coil 130. The four bosses 122 are arranged at four corners of the first bracket 120, respectively, and the four bosses 122 one-to-one correspond to the four avoidance spaces 193. Each boss 122 passes through the corresponding avoidance space 193, thereby preventing the planar circuit board 190 and the imaging sensor 194 from impacting the first bracket 120 in the direction of the optical axis L, thus effectively protecting the planar circuit board 190 and the imaging sensor 194, making the internal structure of the lens driving device more stable, and improving the service life of the lens driving device.

With continued reference to FIG. 2, the upper frame 170 is provided with a plurality of abutment members 171 that can abut against the planar circuit board 190. Since the upper frame 170 is arranged in the first receiving cavity 1101, the abutment members 171 can quickly and effectively position the first bracket 120 and the planar circuit board 190, and can make the structure of the lens driving device more stable.

The first position detection element 182 is configured to transmit an electrical signal including the position information of the first magnet to the planar circuit board. The second position detection element 281 is configured to transmit an electrical signal including the position information of the second magnet to the planar circuit board 190.

In an embodiment of the present disclosure, the first position detection element 182 and the second position detection element 281 each may adopt a Hall element. When the first bracket 120 moves in a plane perpendicular to the optical axis L or in a direction rotating about the optical axis L, the first position detection element 182 moves relative to the first magnet 140, thereby changing the magnetic field of the first magnet 140 at the first position detection element 182. The first position detection element 182 determines a relative position of the first magnet 140 by detecting a change in magnetic flux. When the support bracket 270 moves in the direction along the optical axis L, the second position detection element moves relative to the second magnet 240, thereby changing the magnetic field of the second magnet 240 at the second position detection element. The second position detection element determines a relative position of the second magnet 240 by detecting a change in magnetic flux.

According to the position information of the first magnet 140 and the second magnet 240 fed back by the first position detection element 182 and the second position detection element, positions of the first magnet 140 and the second magnet 240 can be adjusted by controlling the magnitude of the energization current to the planar circuit board 190, thereby achieving more accurate focusing of the lens 100.

Referring to FIG. 3 and FIG. 15, the support bracket 270 is formed as a square ring shape, two spring pieces 290 are arranged at two opposite corners of the support bracket 270, and the spring pieces 290 are electrically connected to the second circuit board 280. The spring piece 290 is soldered with solder balls to electrically connect the second circuit board 280 to a tail pad 282 of the second circuit board 280, and finally electrically connect the second circuit board 280 to the planar circuit board 190, so that the second position detection element 281 transmits an electrical signal to the planar circuit board 190.

In an example, a mounting hole 181 is formed at the first circuit board 180, and can be plugged with a coil mounting block 125 at the first bracket 120. The coil mounting block 125 passes through the mounting hole 181, so that the first coil 130 is stably arranged at the first circuit board 180. One coil corresponds to at least two coil mounting blocks 125. The planar circuit board 190 is connected to a side of the first bracket 120 away from the first coil 130, and the bottom plate 113 is arranged at a bottom of the planar circuit board 190. The planar circuit board 190 further includes an extension plate 191 that extends outside the first receiving cavity 1101. The side plate 112 is provided with a through-hole for the extension plate 191 to extend through, allowing the extension plate 191 to conduct electricity for an entire lens driving device. In an embodiment of the present disclosure, the bottom plate 113 is laser welded to the first shell 110 to form a whole, and the welding joint is sealed with adhesive.

Further, a connection plate 192 is provided at an end of the extension plate 191 away from the planar circuit board 190. A conductive contact 132 is provided at the connection plate and is configured to transmit a current. The connection plate 192 is fixed to the extension plate 191, and the conductive contact 132 is fixed to the connection plate 192. The lens driving device may be electrically connected to another device through the conductive contact 132.

A metal gasket 124 is provided between the planar circuit board 190 and the first bracket 120, for buffering movement of the lens driving device during movement. In some embodiments of the present disclosure, the metal gasket 124 may be made of high-carbon steel or brass.

The first position detection element 182 is arranged at the first circuit board 180 and the second position detection element 281 is arranged at the second circuit board 280 by a Surface Mounted Technology (SMT), so that the first position detection element 182 and the second position detection element 281 transmit electrical signals to the planar circuit board 190.

In an embodiment of the present disclosure, the second bracket 220 is provided with a first fixation block 221, and the support bracket 270 is provided with a second fixation block 272. The first fixation block 221 and the second fixation block 272 each include an arc surface.

During the assembling process, the first fixation block 221 and the second fixation block 272 are snapped together to form a second receiving groove, to arrange the ball set 260.

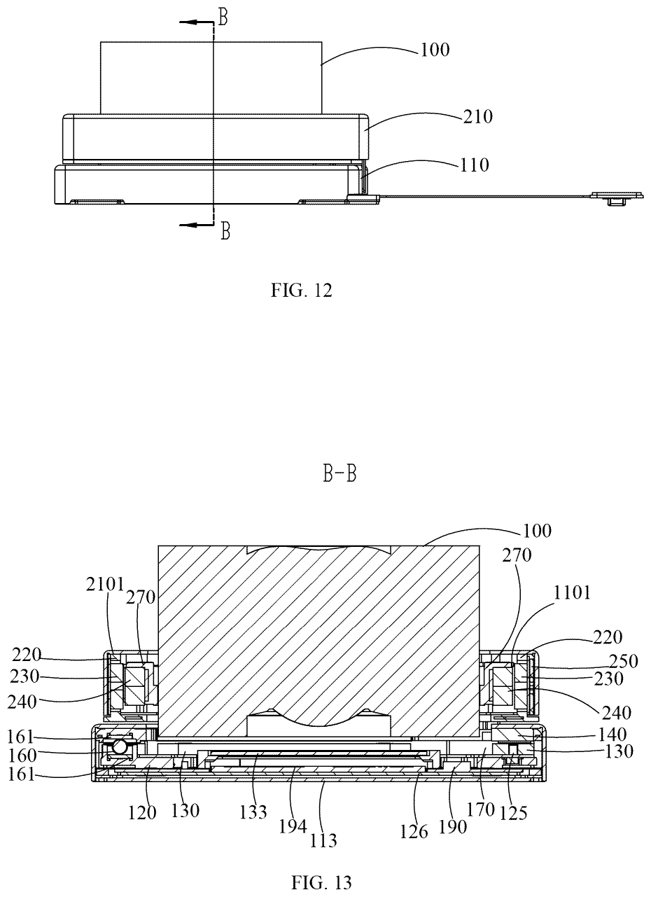

As shown in FIG. 3, FIG. 12 and FIG. 13, the ball set 260 includes three second balls 261 arranged in the direction of the optical axis L. A diameter of each of the two second balls 261 respectively adjacent to an object side and an image side is larger than a diameter of a second ball 261 located at the middle position. In some embodiments, the diameter of each of the two second balls 261 respectively adjacent to the object side and the image side is within a range from 0.6 mm to 1.0 mm, for example, 0.6 mm, 0.7 mm, 0.8 mm, 0.9 mm, or 1.0 mm, and the diameter of the second ball 261 located at the middle position is within a range from 0.55 mm to 0.95 mm, for example, 0.55 mm, 0.65 mm, 0.75 mm, 0.85 mm, or 0.95 mm. Therefore, the stability of the ball set 260 is improved. At the same time, the second ball 261 located at the middle position serves as a spacer to prevent the second ball 261 from being stuck during rolling.

In an embodiment of the present disclosure, the first shell 110 is configured as a magnetic shell, which may be made of SUS430. An outer housing of the second shell 210 may be not magnetic, which may be made of SUS316L.

In the embodiments of the present disclosure, the auto focusing device and the optical image stabilization device are configured as two independent structures, which are independently formed and processed and then assembled, effectively reducing the yield loss in the manufacturing process of the lens driving device, thereby reducing the manufacturing cost. Meanwhile, two types of balls are provided at the auto focusing device and at the optical image stabilization device, respectively, thereby further improving the image stabilization performance of the lens driving device.

Another aspect of the embodiments of the present disclosure further provides an optical apparatus, including the lens driving device as described in any one of the above-mentioned embodiments, and the lens driving device is arranged in the optical apparatus.

FIG. 9 is a schematic structural diagram of a lens driving device assembled with a lens according to an embodiment of the present disclosure. As shown in FIG. 9, after the first shell 110 is assembled with the second shell 210, the lens 100 is assembled with the lens driving device. It can be understood that, electronic devices in the embodiments of the present disclosure may be a portable terminal such as a smart phone, a tablet computer, a laptop computer, or a smart watch.

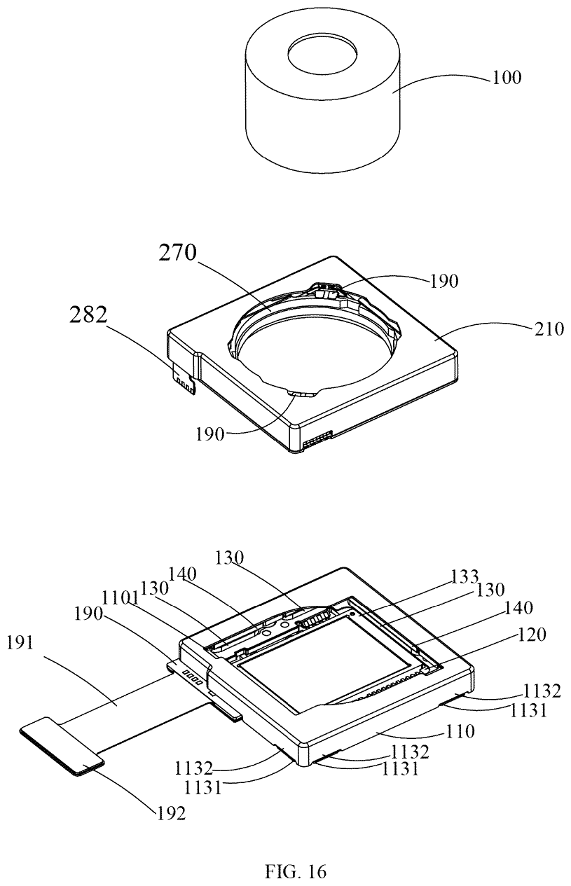

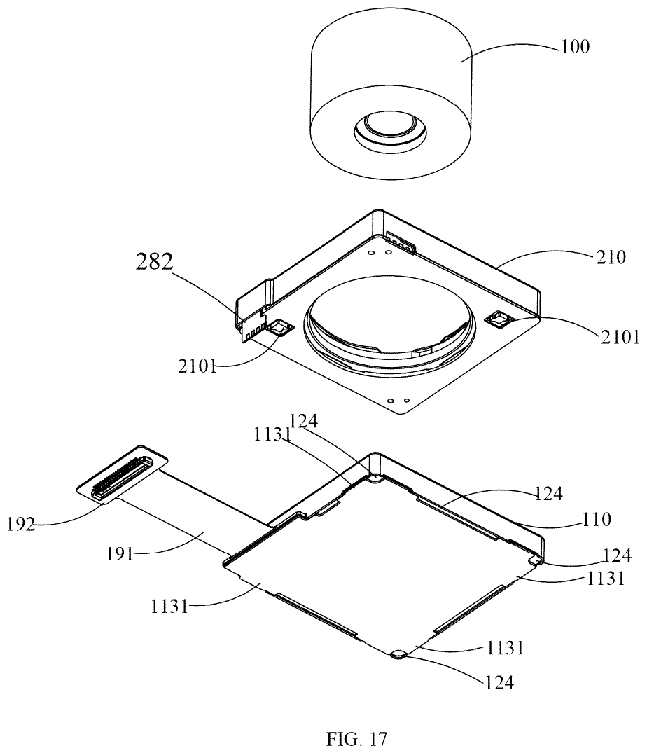

Further, referring to FIG. 7, FIG. 16 and FIG. 17, it can be seen that, referring to FIG. 12 and FIG. 13, the bottom plate 113 covers a side of the planar circuit board away from the first shell 110, and a convex portion 1131 extending outwards from the bottom plate 113 is formed at an edge of the bottom plate 113. A concave portion 1132 is formed at an edge of the first shell 110. The concave portion 1132 may be configured to receive the convex portion 1131. The convex portion 1131 and the concave portion 1132 are fixed together by laser welding, which not only forms firm fixation, but also is convenient for production. A gap between the first shell 110 and the bottom plate 113 is sealed with adhesive, thereby effectively fixing the first shell 110 and the bottom plate 113, and protecting components inside the first shell 110.

Meanwhile, a limiting hole 1101 is formed in the top plate 111 of the first shell 110, and a limiting boss 2101 is provided at a side of the second shell 210 facing the top plate 111. The limiting hole 1101 is aligned with the limiting boss 2101 in the vertical direction, and the limiting boss 2101 can be inserted into the limiting hole 1101, thereby allowing the first shell 110 to be quickly and effectively positioned at the second shell 210.

Those skilled in the art can understand that the above-mentioned embodiments are merely some embodiments of the present disclosure, and in practical applications, various changes may be made in forms and details without departing from a spirit and a scope of the present disclosure. Any person skilled in the art can make various changes and modifications without departing from the spirit and the scope of the present disclosure, and thus the scope of the present disclosure shall be defined by the claims.

What is claimed is:

1. A lens driving device capable of mounting an imaging sensor and a lens having an optical axis, wherein the lens driving device comprises:
a first shell comprising a first receiving cavity;
a first bracket movably arranged in the first receiving cavity and configured to fix the imaging sensor;
a first coil fixed to the first bracket;
a first magnet fixed in the first shell and arranged opposite to the first coil along a direction of the optical axis;
a first ball arranged between the first bracket and an inner wall of the first shell;
a first magnetic conductor fixed to the first bracket and arranged opposite to the first magnet, wherein an attractive force is generated between the first magnetic conductor and the first magnet to cause the first bracket and the first shell to clamp the first ball, and the first magnet drives the first coil to drive the first bracket and the imaging sensor to move in a plane perpendicular to the optical axis when the first coil is energized;
a first position detection element configured to detect a position of the first magnet;
a second shell comprising a second receiving cavity and fixedly connected to an object side of the first shell;
a support bracket arranged in the second receiving cavity and comprising a through-hole, wherein the lens is arranged in the through-hole;
a second bracket arranged at a periphery of the support bracket;
a second magnet fixed to the support bracket;
a second coil fixed in the second shell, arranged opposite to the second magnet and at a side of the second magnet away from the optical axis;
a ball set arranged in a gap between the second bracket and the support bracket;
a second magnetic conductor arranged opposite to the second magnet, wherein an attractive force is generated between the second magnetic conductor and the second magnet to cause the second bracket and the support bracket to clamp the ball set, the second magnet drives the second coil to drive the support bracket and the lens to move along the direction of the optical axis when the second coil is energized; and
a second position detection element configured to detect a position of the second magnet.

2. The lens driving device as described in claim 1, further comprising:
an upper frame arranged in the first receiving cavity,
wherein the upper frame abuts against the first shell; a surface of the first bracket facing the upper frame is provided with at least one first receiving groove, each of the at least one first receiving groove and a plane of the upper frame facing the first bracket form a receiving space, and one first ball is received in one receiving space.

3. The lens driving device as described in claim 2, further comprising:
a ball support plate, wherein two ball support plates are provided and arranged at an object side and an image side of the first ball, and one ball support plate is arranged at a bottom of the first receiving groove.

4. The lens driving device as described in claim 1, wherein the ball set comprises three second balls arranged along the direction of the optical axis, and wherein a diameter of each of two second balls adjacent to an object side and an image side is greater than a diameter of a second ball arranged at a middle position.

5. The lens driving device as described in claim 4, wherein the diameter of each of the two second balls adjacent to the object side and the image side is within a range from 0.6 mm to 1.0 mm, and the diameter of the second ball arranged at the middle position is within a range from 0.55 mm to 0.95 mm.

6. The lens driving device as described in claim 1, wherein the support bracket is provided with a clamping groove along a circumferential direction, and a side of the second magnet away from the second coil abuts against an inner wall of the clamping groove.

7. The lens driving device as described in claim 1, further comprising:
a first circuit board sandwiched between the first coil and the first bracket and electrically connected to the first position detection element;
a second circuit board provided between the second magnetic conductor and the second bracket and electrically connected to the second position detection element; and
a planar circuit board fixedly connected to the first shell and electrically connected to the first circuit board.

8. The lens driving device as described in claim 7, wherein the first position detection element is configured to transmit an electrical signal comprising a position information of the first magnet to the planar circuit board.

9. The lens driving device as described in claim 7, wherein the second position detection element is configured to transmit an electrical signal comprising a position information of the second magnet to the planar circuit board.

10. The lens driving device as described in claim 7, further comprising:
a spring piece, wherein the support bracket is formed as a square ring shape, two spring pieces are provided and arranged at two opposite corners of the support bracket, and the spring piece is electrically connected to the second circuit board.

11. The lens driving device as described in claim 1, wherein the first magnet drives the first coil to drive the first bracket and the imaging sensor to move along the direction of the optical axis when the first coil is energized.

12. The lens driving device as described in claim 1, wherein four bosses are provided at a surface of the first bracket away from the first coil, and the four bosses are arranged at four corners of the first bracket.

13. An optical apparatus, comprising a lens driving device capable of mounting an imaging sensor and a lens having an optical axis, wherein the lens driving device comprises:
a first shell comprising a first receiving cavity;
a first bracket movably arranged in the first receiving cavity and configured to fix the imaging sensor;
a first coil fixed to the first bracket;
a first magnet fixed in the first shell and arranged opposite to the first coil along a direction of the optical axis;
a first ball arranged between the first bracket and an inner wall of the first shell;
a first magnetic conductor fixed to the first bracket and arranged opposite to the first magnet, wherein an attractive force is generated between the first magnetic conductor and the first magnet to cause the first bracket and the first shell to clamp the first ball, and the first magnet drives the first coil to drive the first bracket and the imaging sensor to move in a plane perpendicular to the optical axis when the first coil is energized;
a first position detection element configured to detect a position of the first magnet;
a second shell comprising a second receiving cavity and fixedly connected to an object side of the first shell;
a support bracket arranged in the second receiving cavity and comprising a through-hole, wherein the lens is arranged in the through-hole;
a second bracket arranged at a periphery of the support bracket;
a second magnet fixed to the support bracket;
a second coil fixed in the second shell, arranged opposite to the second magnet and at a side of the second magnet away from the optical axis;
a ball set arranged in a gap between the second bracket and the support bracket;
a second magnetic conductor arranged opposite to the second magnet, wherein an attractive force is generated between the second magnetic conductor and the second magnet to cause the second bracket and the support bracket to clamp the ball set, the second magnet drives the second coil to drive the support bracket and the lens to move along the direction of the optical axis when the second coil is energized; and
a second position detection element configured to detect a position of the second magnet.
